(19) United States
(12) Patent Application Publication
(10) Pub. No.: US 2025/0234840 A1
(43) Pub. Date: Jul. 24, 2025

(54) SYSTEM METHOD FOR GENERATING ANIMAL CERTIFICATES

(71) Applicant: GlobalVetLink, L.C., Ames, IA (US)

(72) Inventor: Stephen James Adamson, Des Moines, IA (US)

(73) Assignee: GlobalVetLink, L.C., Ames, IA (US)

(21) Appl. No.: 18/986,094

(22) Filed: Dec. 18, 2024

Related U.S. Application Data
(60) Provisional application No. 63/616,494, filed on Dec. 29, 2023.

(51) Int. Cl. A01K 11/00; G06F 16/532; G06K 19/06; G06V 40/10

(52) U.S. Cl. CPC A01K 11/006; G06F 16/532; G06K 19/06037; G06V 40/10

(57) ABSTRACT

A method for generating a certificate for an animal is provided. The method can include obtaining, from at least one sensor, an animal related input of the animal, and obtaining, from an animal database, animal data based on the animal related input. The method can also include analyzing by one or more processors, the obtained animal related input and animal data to determine an identity of the animal, and obtaining, by the one or more processors, additional animal data based on the identity of the animal. The method can also include automatically generating, with the one or more processors, a certificate that includes an indicator based on the additional animal data.

### CROSS-REFERENCE

This application is claims priority to and the benefit of U.S. Provisional Application No. 63/616,494, filed Dec. 29, 2023.

### FIELD

This invention relates to methods and systems for generating animal certificates and verifying animal data and information.

### BACKGROUND

Animals are a part of most individuals' day-to-day lives. Whether an animal is a pet such as a cat or dog, a horse used to ride or race, cattle used to feed individuals, animals have a significant effect on the world. As a result, rules and governmental bodies have been formed specifically for animals. Such rules can include ensuring pets are vaccinated, cattle are healthy, or the like. Governmental bodies can include the Food and Drug Administration (FDA), the United States Department of Agriculture (USDA), Animal Plant Health Inspection Services (APHIS), Veterinary Services (VS), or the like. In addition, numerous state-based agencies also exist that regulate animals.

A problem exists in that nefarious individuals often do not desire to pay for expenses associated with owning animals to meet all regulatory requirements. Instead, individuals can be untruthful, forge certificates, etc. to avoid these costs. For example, when selling cattle, certificates are required to prove the health of the cattle, vaccines, exposures to disease, veterinary records, or the like. A nefarious individual can decide not to get the proper vaccines for cattle, fail to report exposure to viruses such as swine flu, or the like in an effort to save money and sell off diseased cattle.

In addition, problems can also occur with record keeping in general. Sometimes individuals take all steps to meet regulatory requirements, but simply lose paperwork, do not fill out paperwork in the correct manner, etc. that makes it difficult to prove the animals meet all regulations. As a result, individuals can have a difficult time selling animals to individuals that are concerned with potentially being scammed by the individual.

Additionally, electronic devices such as a generic computer typically process information related to animal paperwork slowly and inefficiently. Such information is typically stored in a memory or files without any organization resulting in a user to have to scroll through files, remember file names, look through icons on a home screen or the like. Additionally, generic computers have no manner to check to ensure accuracy of information being provided and can have little to no security related to the electronic device.

In all, there is a need for a system that can help track animals and health services performed on such animals. The system needs to provide quick and easy methodology for identifying an animal, along with all records, certificates, paperwork, etc. associated with that animal.

### SUMMARY

In one or more embodiments, a method for generating a certificate for an animal is provided. The method can include obtaining, from at least one sensor, an animal related input of the animal, and obtaining, from an animal database, animal data based on the animal related input. The method can also include analyzing by one or more processors, the obtained animal related input and animal data to determine an identity of the animal, and obtaining, by the one or more processors, additional animal data based on the identity of the animal. The method can also include automatically generating, with the one or more processors, a certificate that includes an indicator based on the additional animal data.

Optionally, the at least one sensor can be a camera. In one aspect, obtaining the animal data may include communicating with a remote animal database at a different location than the one or more processors. In another aspect, analyzing by the one or more processors, the obtained animal related input and the animal data may include utilizing artificial intelligence to determine the identity of the animal. In yet another aspect, analyzing by the one or more processors, the obtained animal related input and the animal data can include comparing an image obtained by the at least one sensor to a prior image obtained from the animal database. In one example the indicator can be a QR code.

Optionally, automatically generating the certificate can include printing the certificate with the indicator. In one aspect, the indicator may include the additional animal data embedded therein. In another aspect the additional animal data can include at least one of health records, vaccine records, or transportation records. In one example the animal may be at least one of a dog, cat, equine, bovine, or swine.

In one or more embodiments, a method for verifying information related to an animal is provided. The method can include obtaining, with one or more processors, third-party animal data related to an animal, and obtaining, from at least one sensor, an animal related input of the animal. The method can also include obtaining, from an animal database, animal data based on the animal related input, and analyzing by one or more processors, the obtained animal related input and animal data to determine an identity of the animal. The method can also include verifying the third-party animal data based on the analyzing, and automatically generating, with the one or more processors, a prompt to communicate to a user whether the animal is verified.

Optionally, analyzing the obtained animal related input and animal data to determine the identity of the animal may include determining a remote electronic device with a remote animal database based on the animal related input and animal data, selecting a format for providing the animal related input and the animal data, and converting a file into the format selected prior to communicating the file to the remote electronic device. In one aspect, analyzing the obtained animal related input and animal data to determine the identity of the animal can also include receiving a verification communication from the remote electronic device. In another aspect, analyzing by the one or more processors, the obtained animal related input and the animal data may include utilizing artificial intelligence to determine the identity of the animal. In one example analyzing by the one or more processors, the obtained animal related input and the animal data ca include comparing an image obtained by the at least one sensor to a prior image obtained from the animal database. In another example, the animal may be at least one of a dog, cat, equine, bovine, or swine.

In one or more embodiments, an electronic device is provided for generating a certificate for an animal. The electronic device can include at least one sensor configured to obtain an animal related input of the animal. The electronic device can also include a memory to store executable instructions and one or more processors. When implementing the executable instructions the one or more processors are configured to obtain, from an animal database, animal data based on the animal related input, and analyze the obtained animal related input and animal data to determine an identity of the animal. The one or more processors can also be configured to obtain additional animal data based on the identity of the animal, and automatically generate a certificate that includes an indicator based on the additional animal data.

Optionally, the at least one sensor can be a camera. In one aspect, to obtain the animal data may include communicating with a remote animal database at a different location than the one or more processors. In another aspect, to analyze the obtained animal related input and the animal data can include utilizing artificial intelligence to determine the identity of the animal.

### BRIEF DESCRIPTION OF THE FIGURES

FIG. 1 is schematic diagram of a system for verifying animal data, in an embodiment.

FIG. 2 is a schematic block diagram of an electronic device for verifying animal data, in one embodiment.

FIG. 3 is a schematic diagram of a certificate, in one embodiment.

FIG. 4 is a block flowchart illustrating a method for verifying the identity of an animal, in an embodiment.

FIG. 5 is a block flowchart illustrating a method for generating a certificate, in an embodiment.

### DETAILED DESCRIPTION OF THE EMBODIMENTS

The term “obtains” and “obtaining”, as used in connection with data, signals, information and the like, include at least one of i) accessing memory of a remote device or remote server where the data, signals, information, etc. are stored, ii) receiving the data, signals, information, etc. over a wireless communications link a monitoring system and a remote device, and/or iii) receiving the data, signals, information, etc. at a remote server over a network connection. The obtaining operation, when from the perspective of a monitoring system, may include sensing new signals in real time, and/or accessing memory to read stored data, signals, information, etc. from memory within the monitoring system. The obtaining operation, when from the perspective of a remote device, includes receiving the data, signals, information, etc. at a transceiver of the remote device where the data, signals, information, etc. are communicated from a monitoring system and/or a remote server. The obtaining operation may be from the perspective of a remote server, such as when receiving the data, signals, information, etc. at a network interface from a remote device and/or directly from a monitoring system. The remote server may also obtain the data, signals, information, etc. from local memory and/or from other memory, such as within a cloud storage environment and/or from the memory of a workstation or remote programmer.

The present disclosure presents systems and methods for improving the processing, use, and security of an electronic device when used to identify animals and generate verifiable certificates related to the animals. In one example an indicator, such as a unique QR code, is placed on each certificate that when scanned can show the key data elements for that certificate from an animal database. This allows people to compare what is on the certificate with how the certificate was originally generated. Additionally, users can upload a copy of the document that they have for verification that individuals have not tampered with the certificate or documentation. In one example, artificial intelligence, and/or optical character recognition (OCR) can be utilized to provide the verification. Each certificate may also be automatically sent to the appropriate regulatory authority (federal, state, or local) in real time in the format required by the governing body. This varies from just sending the data from the certificate to a copy of the PDF itself. In addition, the system automatically selects the manner in which the certificates can be sent, including using various methods such as API, email, FTP, etc. In another example, the animal owner can securely share the certificate with others as needed. This might include the animal agent (such as in the case of equine) or the pet groomer/boarder (in the case of companion animals). These certificates may also be sent to animal transportation companies or the new owner in the case of a sale. Finally, the system ensures certificates are compliant by utilizing a modern rules engine based on regulatory requirements to continuously monitor in real time for any changes in regulations by cities, municipalities, states, the federal government, or the like.

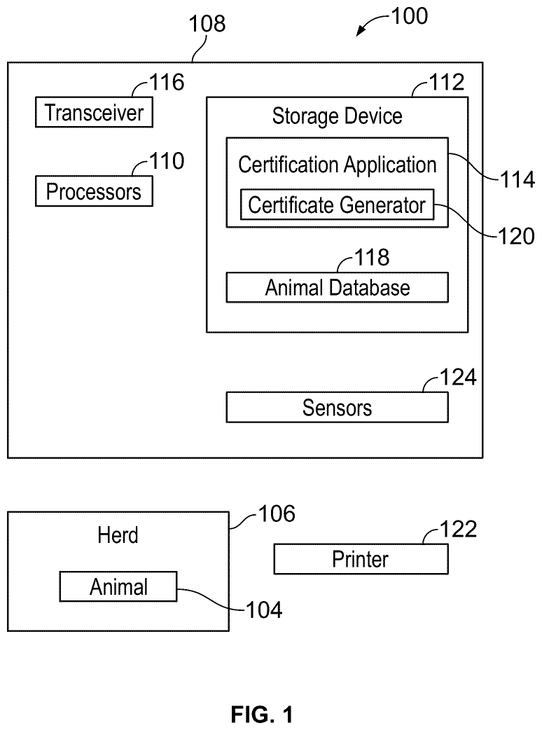

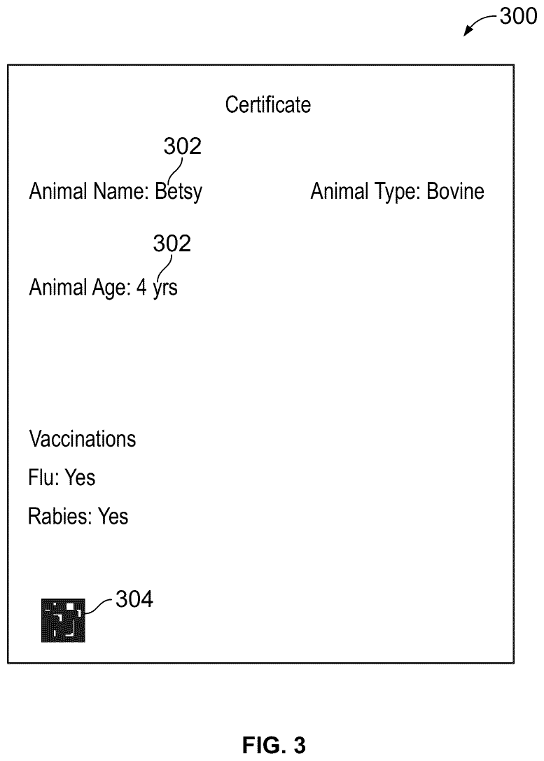

FIG. 1 illustrates a certification system 100 that may be used to verify an animal certificate (FIG. 3). In one example, the animal certificate is for an animal 104 that can be in a herd 106. Alternatively, the animal 104 can be a domesticated animal such as a pet. The animal 104 may include a cow, swine, chicken, equine, bovine, goat, sheep, fish, dog, cat, avian, or the like, and the herd 106 may include livestock, a school of fish, a pack of two or more animals, etc. In one example, the herd 106 has at least ten animals.

The certification system 100 may include an electronic device 108 such as a laptop computer, computer processing unit (CPU), smart phone, smart watch, iPad, tablet, FitBit, etc. The electronic device 108 can include one or more processors 110 used to make determinations, calculations, estimations, operate software, perform methods, perform algorithms, etc. The one or more processors may utilize algorithms, look-up tables, decision trees, artificial intelligence, OCR, or the like in forming the animal certificate, verifying the animal certificate, sending or transmitting the animal certificate, converting the animal certificate into digital file, or the like.

In addition, the electronic device 108 can have a memory 112 or storage device that can include a certification application 114. The certification application 114 is configured to provide instructions for execution by components of the electronic device 108 including the one or more processors to obtain data and information, create indicators or QR codes, analyze data and information, make determinations, or the like.

The electronic device 108 can also include a transceiver 116 for communicating with an animal database 118 to obtain animal data. In one example the animal database 118 is remote from the electronic device 108 and communication can be provided over a network. In one example, transceiver 116 may utilize a communication protocol such as Wi-Fi, Bluetooth, other short range telemetric connection, or the like to operate the communication protocol in a peer-to peer mode. Alternatively the animal database 118 can be in the memory 112, in a cloud, etc. The animal database 118 can include animal data including information, pictures, immunization records, transportation records, feed schedules, vaccination records, veterinarian records, or the like associated with the animal 104. Such data and information can be obtained from public databases, private databases, input into the animal database 118, etc.

The certification application 114 may also include a certificate generator 120. A certificate generator 120 may obtain information from the memory 112 in order to generate a certificate that may be used by the owner of an animal 104 or herd 106. In one example, the certificate generator 120 described in U.S. patent Ser. No. 15/311,467 entitled System and Method for Predicting Effectiveness of Animal Treatments to Mahar that is incorporated in full herein, is the certificate generator 120. In an example, the certification application 114 generates certificates (see FIG. 3) that include an indicator (FIG. 3) thereon. An indicator can include a code, QR code, bar code, symbol, picture, image, or the like that contains information or data that can be obtained therefrom. For example, a QR code may be provided that when scanned can provide authenticating information related to the animal 104, vaccination information, identification information, movement information, or the like. In this manner the indicator can be a unique pattern, code, etc. that can provide verification printed in indicia on a certificate itself.

In one example, in order for an animal 104 to cross state lines, often a certificate is needed showing that the animal 104 has had appropriate vaccinations and is in good health. An algorithm may be used in association with rules and regulations to electronically receive a certificate that includes an indicator such as a QR code. In one example, the algorithm can analyze data files obtained from a memory, third party electronic device, a remote server, or the like, increasing the processing for populating the certificate and generating the indicator. Based on the state an animal 104 is entering the rules and regulations of that state may be obtained, then the certificate system 100 may obtain from the memory 112, or through communication with a remote device, such as veterinarian associated with an animal 104 or herd 106 all vaccines an animal 104 or herd 106 has received. Based on a control signal from the electronic device 108, an electronic message, such as an email, may then be generated by the electronic device 108 that includes a certificate attached in a file, such as a pdf, with required information already filled out and a message to a veterinarian that the animal 104 or herd 106 is crossing state lines within a predetermined period of time, and requesting an electronic signature be added and emailed back to the requester. In this manner, the certificate generator 120 forms an email with an attachment that has specific information that reduces the time in receiving certificates. Upon receiving the return email with the executed certificate, the certificate generator 120 may be in communication with a printer 122 that automatically prints the executed certificate for use when crossing a state line.

In one example, an artificial intelligence algorithm may be used to determine based on weights whether a specific animal 104 is the animal being certified. In particular, each variable of information obtained may be given an individual weight in determining the likelihood of an animal is the correct animal being certified. For example, an image of the animal 104 can be obtained from a sensor 124 such as a camera and analyzed for facial recognition and may be given a weight of 4. Other sensors can include global navigation systems such as global positioning sensors (GPS). As such, proximity of the last location could be given a weight of 2. Other sensors for scanning bar codes, or other information including ear tags, other identification material, etc. can similarly be provided a weight. If a probability reaches above a predetermined threshold, such as 95%, the certification can be generated.

To this end, the certification system 100 may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems.

Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like.

In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for verifying an animal, generating a certificate, or the like.

In one embodiment, the control system may include a policy engine that may apply one or more policies. These policies may be based at least in part on characteristics of a given item of equipment or environment. With respect to control policies, a neural network can receive input of a number of environmental and task-related parameters. These parameters may include an identification of a determined feed schedule or transportation schedule, data from various sensors, and location and/or position data. The neural network can be trained to generate an output based on these inputs, with the output representing a certificate that includes identifying indicia, or verification of the identity of an animal.

During operation of one embodiment, a determination can occur by processing the inputs through the parameters of the neural network to generate a value at the output node designating information for the certificate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the certificate can be generated. Additionally, the success metric may be a combination of the optimized outcomes, which may be weighed relative to each other.

The controller can use this artificial intelligence or machine learning to receive input (e.g., a location or change in location of an animal), use a model that associates locations with different animal characteristics and/or parameters to verify the identity of an animal (e.g., the animal selected using the model). The controller may receive additional input of animal that was selected, such as analysis of noise or interference in communication signals (or a lack thereof), operator input, or the like, which indicates whether the machine-selected animal provided a desirable (e.g., correct) outcome or not. Based on this additional input, the controller can change the model, such as by changing which animal would be selected when a similar or identical location or change in location is received the next time or iteration. The controller can then use the changed or updated model again to select an animal, receive feedback on the selected animal, change or update the model again, etc., in additional iterations to repeatedly improve or change the model using artificial intelligence or machine learning.

In addition to generating a certificate, in one embodiment the certification application 114 may verify whether a produced certificate associated with an animal 104 is authentic. Users can upload a copy of a document such as a certificate for analysis. In one example artificial intelligence as described above may be utilized in a similar manner as previously described to verify the certificate. In another example a sensor 124 such as an optical character recognition (OCR) sensor can be utilized to provide the verification of the document. Alternatively, a document, or certificate, may be automatically analyzed and sent to the appropriate regulatory authority (federal, state, or local) in the format required by the governing body. To this end, the one or more processors determine the type of document being provided based on information or data received from sensor, automatically determines in real time the format of the document that is acceptable for that agency, and automatically in real time converts the document into a file of that format. Then, in real time, the one or more processors automatically send or transmit the reformatted document to the regulatory body. This varies from just sending the data from the certificate to a copy of the PDF itself. In addition, the system automatically selects the manner in which the certificates can be sent, including using various methods such as API, email, FTP, etc. In example embodiments such functionality can be determined using a lookup table, using a decision tree, using modeling, using mathematical function, using artificial intelligence, or the like. As a result of providing this functionality in real time, time is saved, and a user does not have to look up how to accomplish these functions.

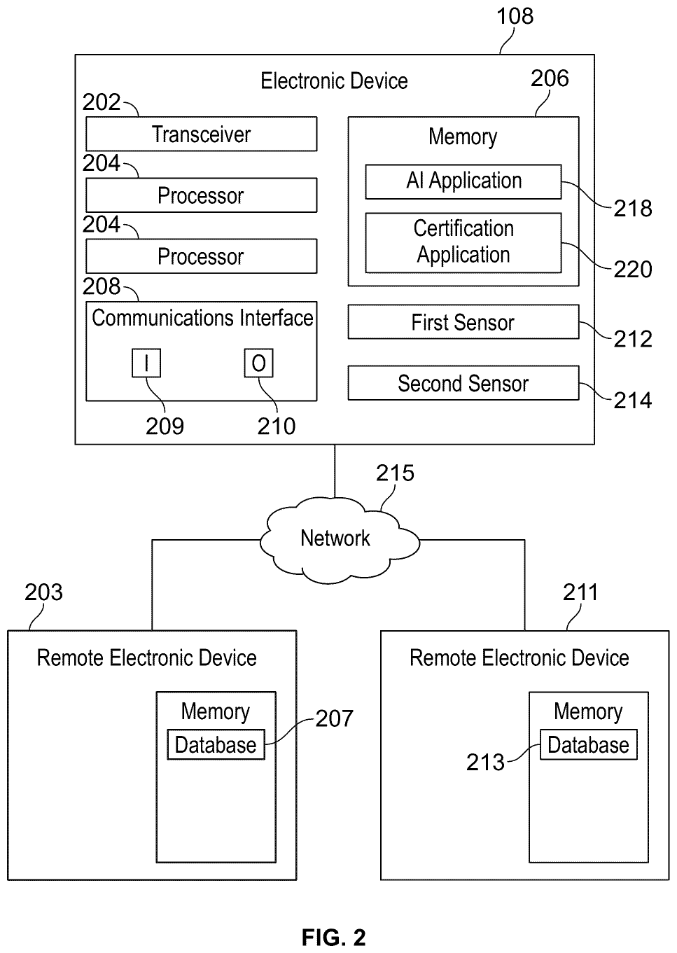

FIG. 2 illustrates a simplified block diagram of the electronic device 108 of FIG. 1 in accordance with an embodiment. While described as the electronic device 108, in other embodiments the device illustrated may be a remote 203 electronic device. The primary electronic device 108 includes components such as one or more wireless transceivers 202, one or more processors 204 (e.g., a microprocessor, microcomputer, application-specific integrated circuit, etc.), and one or more local storage medium (also referred to as a memory portion) 206.

Each transceiver 202 can utilize a known wireless technology for communication. Exemplary operation of the wireless transceivers 202 in conjunction with other components of the electronic device 108 may take a variety of forms and may include, for example, operation in which, upon reception of wireless signals, the components of electronic device 108 detect communication signals from the remote electronic devices 203 and the transceiver 202 demodulates the communication signals to recover incoming information, such as responses to inquiry requests, voice and/or data, transmitted by the wireless signals. The one or more processors 204 format outgoing information and convey the outgoing information to one or more of the wireless transceivers 202 for modulation to communication signals. The wireless transceiver(s) 202 conveys the modulated signals to a remote device, such as a cell tower or a remote server (not shown).

The local storage medium 206 can encompass one or more memory devices of any of a variety of forms (e.g., read only memory, random access memory, static random-access memory, dynamic random-access memory, etc.) and can be used by the one or more processors 204 to store and retrieve data. The data that is stored by the local storage medium 206 can include, but need not be limited to, operating systems, applications, obtained animal data, and informational data. Each operating system includes executable code that controls basic functions of the device, such as interaction among the various components, communication with external or remote devices via the wireless transceivers 202, and storage and retrieval of applications and context data to and from the local storage medium 206. In one example, the transceivers can be in communication with a remote electronic device 203 that includes a remote animal database 207. In addition, the transceivers can also be in communication with other remote devices 211 that have other remote animal databases 213 to communicate animal data and determinations made by the one or more processors 202 and to obtain animal data from one or more remote electronic devices 203. To this end, in one example the remote electronic device 203 can be a service provider that includes an animal database that includes animal data from numerous animal databases. Such numerous animal databases can include regulatory databases including state, federal, and municipal databases. In another example the animal databases can include veterinary databases, feed databases, animal movement databases, or the like. All such databases described can be other remote animal databases 213. In this manner, the electronic device can communicate with numerous other electronic devices and storage devices over a network 215 to obtain animal data and information.

The electronic device 108 in one embodiment also includes a communications interface 208 that is configured to communicate with a network resource. Communications interface 208 can include one or more input devices 209 and one or more output devices 210. The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more status indicators that may be light elements such as light emitting diodes, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof.

The electronic device 202 can also include a first sensor 212, a second sensor 214, an artificial intelligence (AI) application 218, and certification application 220 as described in relation to FIG. 1. All of these components can be operatively coupled to one another, and can be in communication with one another, by way of one or more internal communication links, such as an internal bus. The first sensor 212 and the second sensor 214 both function to obtain animal data. The types of information can include visual, auditory, haptic, infrared, or the like. Example sensors can include cameras, microphones, scanners, infrared cameras, or the like.

The AI application 218 and the certification application 220 in one embodiment are stored within storage medium 206 and each include executable code. Both the AI application 218 and the certification application 220 obtain information, including animal data, from the first sensor 212, second sensor 214, along with other sensors, information input by a user, a remote device, etc. For example, the AI application 218 may obtain the animal data related to a particular animal and the environment of the animal to make determinations related to the identity of the animal and health of the animal. The AI application 218 may also receive auxiliary animal data from any remote device 203, 211 related to that contain information about a particular animal.

Each remote device 203, 211 may have an animal database 207, 213, or memory/storage device for storing information about an animal, herd, flock, or the like. This information may include animal birthday, age, vaccines, feed, weight, family information, health problems, weight gain or loss, heart rate, or the like obtained from the sensors 212, 214. For example, information from a laboratory computing device may include contact information (e.g., name, address and telephone numbers), one or more tube numbers (e.g., a uniquely identifying number identifying a sample within the laboratory), date received, date reported (e.g., the date the test results are reported), test results (e.g., positive or negative), and a signature (e.g., a digital signature indicating that the test results are entered by a certified laboratory technician). The remote device databases 207, 213 can also include animal information related to the managing and caring for animals such that data resulting from lab submission may be processed, together with production performance information, species and genotypic data, and previous treatment results to better predict which treatment has the highest probability of providing a positive impact on a particular animal and/or group of animals, using data of their specific production phase, species category, genotype, and environmental conditions. In all, the remote devices 203, 211 may be used to collect information for analysis to determine the identification of an animal and the health status of such identified animal.

FIG. 3 illustrates an exemplary certificate 300 that can be generated by an electronic device. In one example the systems and devices of FIGS. 1-2 are utilized to generate the certificate 300. The certificate 300 can include animal indicia 302 thereon that provides information related to a particular animal. For example, the animal indicia can include date of birth, age, weight, animal owner, last location, feed information, vaccine records, or the like. In addition, in one example the certificate 300 includes at least one indicator 304. The indicator 304, in example embodiments, can be a code, QR code, symbol, picture, or the like that includes information or data embedded therein. In particular, the indicator 304 is unique to the animal and includes identifying information or data embedded therein that can be scanned or analyzed for verification purposes. In one example, the AI, a random number generator, etc. can be utilized when generating the indicator to ensure the uniqueness of the indicator 304. Thus, security provided by the electronic device is enhanced.

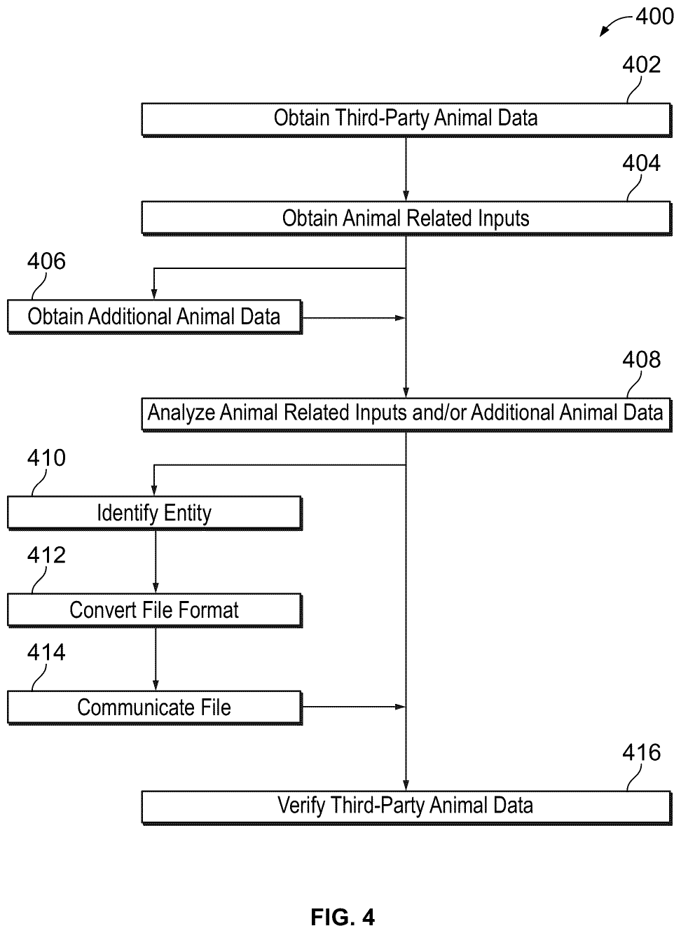

FIG. 4 is a flowchart illustrating one exemplary method 400 for verifying the identity of an animal. In example embodiments the systems of FIGS. 1-2 are utilized to perform one or more steps of the method.

At 402, one or more processors obtain third-party animal data related to an animal. The information can be input into an electronic device after being provided by a third-party. In one example the third-party animal data can be obtained by scanning a certificate or other documentation provided by the third-party related to the animal.

At 404, one or more processors obtain animal related inputs. The animal related inputs can include a picture of the animal obtained from a sensor such as a camera of an electronic device. In another example the animal related inputs can include information input manually into the electronic device. For example, user of the electronic device may ask a question or series of questions related to the animal, herd, etc. and input the answers through an interface for analysis.

At 406, the one or more processors optionally obtain additional animal data based on the animal related inputs obtained. For example, in one example, when the name of an animal is inputted into the electronic device, a communication may be automatically sent to a governmental agency, veterinarian, or the like informing the body the animal is being moved, sold, etc. and requesting the additional animal data. To this end, a veterinarian can send vaccination records or alternative, provide information such as the veterinarian has no records related to the animal. In yet another example, the additional animal data can be a prompt to the user of the electronic device to capture additional sensor-based information, such as a request to scan an car tag, a request to obtain additional images, or the like.

At 408, the one or more processors analyze the animal related inputs and/or additional animal data to determine the identification of the animal. For example, the one or more processors can then verify the information in the certificate, including via use of an OCR, artificial intelligence, or the like. In another example an image captured by a camera (e.g., at least one sensor) is compared to an image in an animal database as at least part of the analysis. In one example, AI is utilized to analyze the inputs by providing weights to each input. The weights are determined as a result of historical data related to similarly situated animals. Then based on whether the determination is correct, such weights can be further varied for future analysis. In this manner, the processing time is decreased and enhanced accuracy of certificate is provided.

At 410, optionally, the one or more processors, based on the animal related inputs identifies one or more governmental agencies, or private locations to communicate a certificate that has been provided. In one example, OCR is utilized to determine a source of a certificate, and/or a source that should be able to verify a provided certificate. Such sources can include the FDA, USDA, a veterinarian, etc.

At 412, in response to identifying the governmental agency or private location, the one or more processors determine a format related to the agency/location and converts the certificate into a file of the format of the agency/location/entity. In particular, there are numerous agencies, private locations, etc. that can receive a certificate including state agencies, city agencies, private certification boards, etc. and each can utilize different formats for their certificates. As such, having a certificate provided in their particular format facilitates searching for the entity as compared to receiving a certificate in a format (e.g., pdf) that is not utilized by the entity. As such, the determination is made, and the certificate file is automatically converted to that format. To make the determination a lookup table, decision tree, or the like can be utilized. By automatically converting to the format, the success of having messages received by a remote electronic device are increased, improving the functionality of the electronic device compared to a generic computing device.

At 414, the converted certificate file is communicated to a selected entity for verification. Thus, once in the correct format the certificate can be sent so that the entity responsible for issuing a certificate, or that can verify the certificate, can do so. In response to the sending, at 416 the one or more processors receive a verification communication from the communication at 414, and verification communication of the identity of the animal is prompted to the user of the electronic device. For example, the prompt box can be provided that indicates, “animal verified” along with additional information. The additional information can include a certainty of the identification, whether a communication was provided by the entity related to the certificate, or the like. In this manner, the individual receiving the verification can have a confidence level in the identification confirmation provided. To this end, if only an 85% certainty can be provided, a user may choose not to accept the certificate, purchase an animal, etc. In this manner, the third-party animal data can be verified by analysis, a remote entity, or combination of the two.

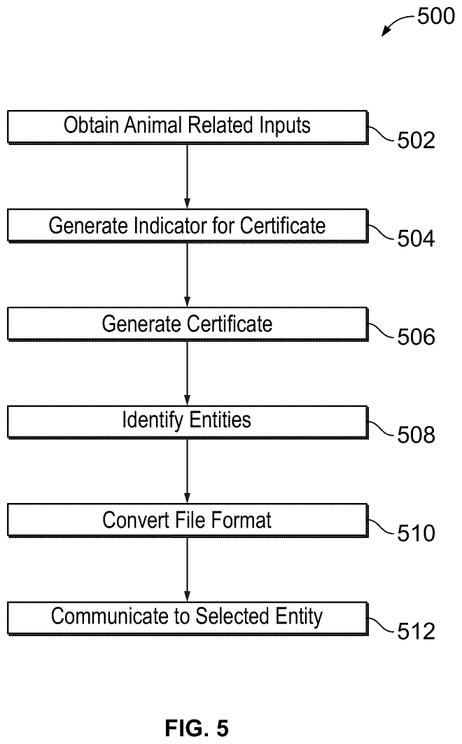

FIG. 5 illustrates a method 500 for generating a verifiable certificate related to an animal. In example embodiments the systems of FIGS. 1-2 are utilized to perform one or more steps of the method.

At 502, one or more processors obtain animal related inputs. The animal related inputs can include a picture of the animal obtained from a sensor such as a camera of an electronic device. In another example, the animal related inputs can include information input manually into the electronic device. For example, user of the electronic device may ask a question or series of questions related to the animal, herd, etc. and input the answers through an interface for analysis. In another example, the animal related inputs can include information uploaded or communicated to the electronic device. Such information can include veterinary records, movement records, feed records, travel records, health records, vaccine records, or the like.

At 504, the one or more processors generate an indicator for the certificate. The indicator can be a unique code, QR code, etc. that is generated by a random number generator, or other method that can be provided as printed indicia. The indicator includes information and data related to the animal that is embedded in the indicator and can be obtained using a sensor, scanner, or the like. The information can include access to links, databases, etc. related to the animal for verification purposes.

At 506, the one or more processors generate the certificate that includes the indicator. In one example the indicator includes embedded animal related inputs, animal data, additional animal data, or the like that can be obtained by scanning or analyzing the indicator. By providing the indicator, a unique method of identification and information sharing is presented. To this end, once generated, the certificate that includes the indicator may be printed for use. In one example printing occurs at a printing device or printer. Alternatively, the printing occurs on an output, screen, display, etc. of an electronic device such that the indicator of the printed certificate (on the output, screen, display, etc.) can be scanned.

At 508, the one or more processors identify entities that are to receive the certificate. Based on the obtained animal related inputs a determination can be made as to which government agencies, private companies, etc. should receive the certificate for future verification purposes.

At 510, in response to identifying the entity, the one or more processors determine a format related to the entity and convert a file of the certificate to the format of the entity. In particular, there are numerous agencies, private locations, etc. that can receive a certificate including state agencies, city agencies, private certification boards, etc. and each can utilize different formats for their certificates. As such, having a certificate provided in their particular format facilitates searching for the entity as compared to receiving a certificate in a format (e.g., pdf) that is not utilized by the entity. As such, the determination is made, and the certificate file is automatically converted to that format. To make the determination a lookup table, decision tree, or the like can be utilized.

At 512, the converted certificate file is communicated to a selected entity. Thus, once in the correct format the certificate can be sent so that the entity so that the entity can include the certificate in their records for future use.

The various methods as illustrated in the Figures and described herein represent exemplary embodiments of methods. The methods may be implemented in software, hardware, or a combination thereof. In various of the methods, the order of the steps may be changed, and various elements may be added, reordered, combined, omitted, modified, etc. Various steps may be performed automatically (e.g., without being directly prompted by user input) and/or programmatically (e.g., according to program instructions).

Various modifications and changes may be made as would be obvious to a person skilled in the art having the benefit of this disclosure. It is intended to embrace all such modifications and changes and, accordingly, the above description is to be regarded in an illustrative rather than a restrictive sense.

Various embodiments of the present disclosure utilize at least one network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, a satellite network and any combination thereof.

In embodiments utilizing a web server, the web server can run any of a variety of server or mid-tier applications, including Hypertext Transfer Protocol (“HTTP”) servers, FTP servers, Common Gateway Interface (“CGI”) servers, data servers, Java servers, Apache servers and business application servers. The server(s) also may be capable of executing programs or scripts in response to requests from user devices, such as by executing one or more web applications that may be implemented as one or more scripts or programs written in any programming language, such as Java®, C, C# or C++, or any scripting language, such as Ruby, PHP, Perl, Python or TCL, as well as combinations thereof. The server(s) may also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU” or “processor”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random-access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed and/or removable storage devices as well as storage media for temporarily and/or more permanently containing, storing, transmitting and retrieving computer-readable information. The system and various devices also typically will include a number of software applications, modules, services, or other elements located within at least one working memory device, including an operating system and application programs, such as a client application or web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Various embodiments may further include receiving, sending, or storing instructions and/or data implemented in accordance with the foregoing description upon a computer-readable medium. Storage media and computer readable media for containing code, or portions of code, can include any appropriate media known or used in the art, including storage media and communication media, such as, but not limited to, volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information, and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

All references, including publications, patent applications and patents, cited herein are hereby incorporated by reference to the same extent as if each reference were individually and specifically indicated to be incorporated by reference and were set forth in its entirety herein.

It is to be understood that the subject matter described herein is not limited in its application to the details of construction and the arrangement of components set forth in the description herein or illustrated in the drawings hereof. The subject matter described herein is capable of other embodiments and of being practiced or of being conducted in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and physical characteristics described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed:

1. A method for generating a certificate for an animal comprising:
obtaining, from at least one sensor, an animal related input of the animal;
obtaining, from an animal database, animal data based on the animal related input;
analyzing by one or more processors, the obtained animal related input and animal data to determine an identity of the animal;
obtaining, by the one or more processors, additional animal data based on the identity of the animal; and
automatically generating, with the one or more processors, a certificate that includes an indicator based on the additional animal data.

2. The method of claim 1, wherein the at least one sensor is a camera.

3. The method of claim 1, wherein obtaining the animal data includes communicating with a remote animal database at a different location than the one or more processors.

4. The method of claim 1, wherein analyzing by the one or more processors, the obtained animal related input and the animal data includes utilizing artificial intelligence to determine the identity of the animal.

5. The method of claim 1, wherein analyzing by the one or more processors, the obtained animal related input and the animal data includes comparing an image obtained by the at least one sensor to a prior image obtained from the animal database.

6. The method of claim 1, wherein the indicator is a QR code.

7. The method of claim 1, wherein automatically generating the certificate includes printing the certificate with the indicator.

8. The method of claim 1, wherein the indicator includes the additional animal data embedded therein.

9. The method of claim 1, wherein the additional animal data includes at least one of health records, vaccine records, or transportation records.

10. The method of claim 1, wherein the animal is at least one of a dog, cat, equine, bovine, or swine.

11. A method for verifying information related to an animal comprising:
obtaining, with one or more processors, third-party animal data related to an animal;
obtaining, from at least one sensor, an animal related input of the animal;
obtaining, from an animal database, animal data based on the animal related input;
analyzing by one or more processors, the obtained animal related input and animal data to determine an identity of the animal;
verifying the third-party animal data based on the analyzing; and
automatically generating, with the one or more processors, a prompt to communicate to a user whether the animal is verified.

12. The method of claim 11, wherein analyzing the obtained animal related input and animal data to determine the identity of the animal includes determining a remote electronic device with a remote animal database based on the animal related input and animal data; selecting a format for providing the animal related input and the animal data; and converting a file into the format selected prior to communicating the file to the remote electronic device.

13. The method of claim 12, wherein analyzing the obtained animal related input and animal data to determine the identity of the animal also includes receiving a verification communication from the remote electronic device.

14. The method of claim 11, wherein analyzing by the one or more processors, the obtained animal related input and the animal data includes utilizing artificial intelligence to determine the identity of the animal.

15. The method of claim 11, wherein analyzing by the one or more processors, the obtained animal related input and the animal data includes comparing an image obtained by the at least one sensor to a prior image obtained from the animal database.

16. The method of claim 11, wherein the animal is at least one of a dog, cat, equine, bovine, or swine.

17. An electronic device for generating a certificate for an animal comprising:
at least one sensor configured to obtain an animal related input of the animal;
a memory to store executable instructions and one or more processors, when implementing the executable instructions, to:
obtain, from an animal database, animal data based on the animal related input;
analyze the obtained animal related input and animal data to determine an identity of the animal;
obtain additional animal data based on the identity of the animal; and
automatically generate a certificate that includes an indicator based on the additional animal data.

18. The electronic device of claim 17, wherein the at least one sensor is a camera.

19. The electronic device of claim 17, wherein to obtain the animal data includes communicating with a remote animal database at a different location than the one or more processors.

20. The electronic device of claim 17, wherein to analyze the obtained animal related input and the animal data includes utilizing artificial intelligence to determine the identity of the animal.
